(19) United States
(12) Patent Application Publication
(10) Pub. No.: US 2026/0138379 A1
(43) Pub. Date: May 21, 2026

(54) INKJET IMAGE FORMING APPARATUS

(71) Applicant: KYOCERA Document Solutions Inc., Osaka-shi (JP)

(72) Inventor: Nobuhiro MAEZAWA, Osaka-shi (JP)

(73) Assignee: KYOCERA Document Solutions Inc., Osaka-shi (JP)

(21) Appl. No.: 19/377,442

(22) Filed: Nov. 3, 2025

(30) Foreign Application Priority Data
Nov. 15, 2024 (JP) 2024-199524

(51) Int. Cl. B41J 2/21; B41J 3/407; B41J 11/00; B41M 5/00

(52) U.S. Cl. CPC B41J 2/2117; B41J 3/407; B41J 11/0022; B41M 5/0017; B41M 5/0047; B41M 5/0064

(57) ABSTRACT

An inkjet image forming apparatus includes aa shite-ink head unit, a precoating head unit, and a color-ink head unit. The white-ink head unit ejects white ink to a printing substrate conveyed in a predetermined conveying direction. The precoating head unit ejects a precoating liquid to the printing substrate. The color-ink head unit is arranged on a downstream side of the white-ink head unit and the precoating head unit in the conveying direction, and ejects color ink other than the white ink to the printing base material. The white ink is ejected from the white-ink head unit to a white image forming region of the printing substrate. The color ink is ejected from the color-ink head unit to a color image forming region of the printing substrate after the white ink is ejected from the white-ink head unit or after the precoating liquid is ejected from the precoating head unit.

### INCORPORATION BY REFERENCE

This application is based on and claims the benefit of priority from Japanese patent application No. 2024-199524 Nov. 15, 2024, which is incorporated by reference in its entirety.

### TECHNICAL FIELD

The present disclosure relates to an inkjet image forming apparatus which forms an image on a printing substrate by an inkjet method.

### BACKGROUND

In an inkjet image forming apparatus, a precoating treatment for ejecting a precoating liquid onto a printing substrate is sometimes performed in order to enhance adhesion between the printing substrate and ink.

For example, there is a case where a pretreatment liquid (corresponding to the precoating liquid) having an ejection amount determined based on a type of the ink and an adhesion amount of the ink ejected per unit area on the recording medium (corresponding to the printing substrate) is ejected.

In general, when a white image is formed on the printing substrate such as a film, a high opacifying ratio (opacity, the degree to which the image cannot be seen through) is required. Therefore, an ejection amount of the white ink is larger than that of the color ink. As the ejection amount increases, an amount of a solvent such as water contained in the ink also increases, and the ink becomes difficult to be dried. To completely dry the ink, a long drying time is required, and a workability is reduced. This tendency is particularly strong in the case of a printing substrate having a smooth surface such as a plastic film.

When the precoating treatment is performed, the solvent contained in the ejected precoating liquid is also contained, so that the dryness is further reduced.

### SUMMARY

An inkjet image forming apparatus according to the present disclosure includes a white-ink head unit, a precoating head unit, and a color-ink head unit. The white-ink head unit ejects white ink to a printing substrate conveyed in a predetermined conveying direction. The precoating head unit ejects a precoating liquid to the printing substrate. The color-ink head unit is arranged on a downstream side of the white-ink head unit and the precoating head unit in the conveying direction, and ejects color ink other than the white ink to the printing base material. The white ink is ejected from the white-ink head unit to a white image forming region of the printing substrate. The color ink is ejected from the color-ink head unit to a color image forming region of the printing substrate after the white ink is ejected from the white-ink head unit or after the precoating liquid is ejected from the precoating head unit.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal configuration of an inkjet image forming apparatus according to one embodiment of the present disclosure.

FIG. 2 is a plan view showing a head unit in the inkjet image forming apparatus according to the embodiment of the present disclosure.

FIG. 3 is a diagram explaining an effect of a precoating treatment in the inkjet image forming apparatus according to the embodiment of the present disclosure.

FIG. 4A is a photograph showing a test image (present embodiment) in the inkjet image forming apparatus according to the embodiment of the present disclosure.

FIG. 4B is a photograph showing a test image (comparative embodiment) in the inkjet image forming apparatus according to the embodiment of the present disclosure.

FIG. 5 is a table showing evaluation results of bleeding and drying time in the inkjet image forming apparatus according to the embodiment of the present disclosure.

FIG. 6 is a table showing components of a color ink, a white ink, and a precoating liquid in the inkjet image forming apparatus according to the embodiment of the present disclosure.

### DETAILED DESCRIPTION

Hereinafter, with reference to the drawings, an inkjet image forming apparatus according to one embodiment of the present disclosure will be described.

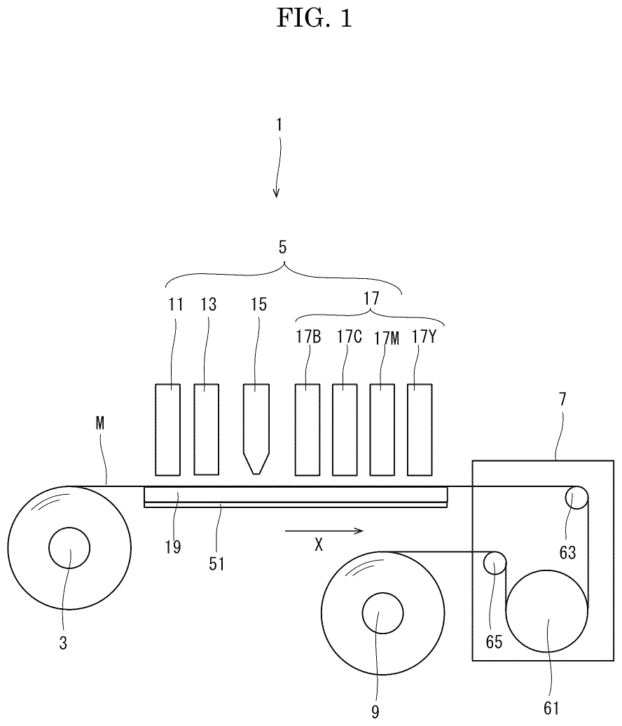

With reference to FIG. 1, the entire configuration of the inkjet image forming apparatus 1 will be described. FIG. 1 is a front view schematically showing the internal configuration of the inkjet image forming apparatus 1.

The inkjet image forming apparatus 1 is provided with a feed roller around which a long printing substrate M is wound, an image forming part 5 which forms an image on the printing substrate M by an inkjet method, a drying part 7 which dries the image formed on the printing substrate M, and a winding roller 9 which winds the printing substrate M.

First, the feed roller 3 will be described. The long printing substrate M is wound and mounted on the feed roller 3. By rotating the feed roller 3, the printing substrate M is fed in a predetermined conveying direction X.

Next, the image forming part 5 will be described. The image forming part 5 is disposed above the printing substrate M fed from the feed roller 3. The image forming part 5 is provided with a precoating head unit 11, a white-ink head unit 13, a warm air blowing nozzle 15, a color-ink head unit 17, and a conveying plate 19 arranged below them, in order from the upstream side in the conveying direction X.

First, the precoating head unit 11 will be described. The precoating head unit 11 ejects a precoating liquid to the printing substrate M fed from the feed roller 3.

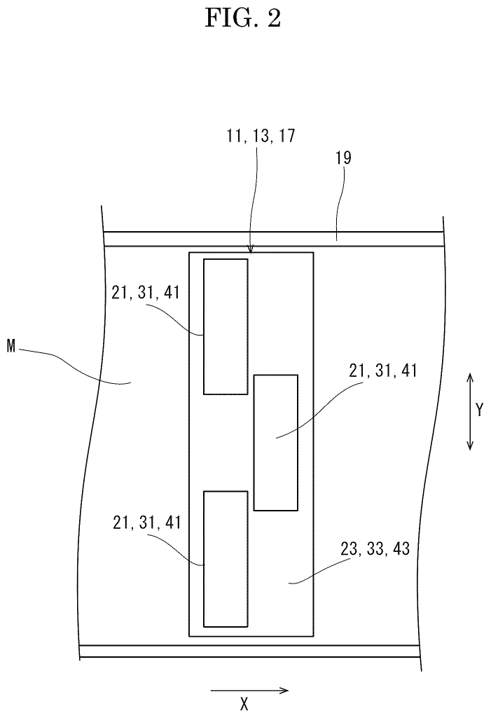

With reference to FIG. 2, the precoating head unit 11 will be described. FIG. 2 is a plan view showing the precoating head unit 11. The precoating head unit 11 is provided with three print heads 21 and a plate 23 for supporting the three print heads 21. The three print heads 21 are arranged in a staggered pattern along the width direction Y (a line head system) so as to have approximately the same width as the width (a length along the width direction Y crossing the conveying direction X) of the printing substrate M, and are supported by the plate 23. A precoating liquid is supplied to the three print heads 21 from a precoating liquid supply source.

The precoating liquid contains, for example, 10% polyester resin (Trade name: Pesresin A-640, manufactured by Takamatsu Resin Co., Ltd.), 0.04% surfactant (Product name: Surfinol 440, manufactured by Nisshin Chemical Industries, Ltd.), 25% propylene glycol, and 64.96% water.

The print head 21 includes a large number of nozzles and a piezoelectric element provided in each nozzle. The nozzle ejection port is opened to the lower surface of the print head 21. When a voltage is applied to the piezoelectric element, the piezoelectric element is deformed, and the precoating liquid in the nozzle is ejected downward through the ejection port.

Next, the white-ink head unit 13 will be described with reference to FIG. 1. The white-ink head unit 13 ejects a white ink onto a white image forming region or a color image forming region on the printing substrate M. The white-ink head unit 13 has the same configuration as the precoating head unit 11 shown in FIG. 2, and includes three print heads 31 and a plate 33 for supporting the three print heads 31. The white ink is supplied to the three print heads 31.

The white ink contains a pigment and a binder resin. The pigment is titanium oxide and the binder resin is polyurethane resin. The binder resin may be the same as or different from the binder resin (polyester resin) of the precoating liquid. The viscosity of the white ink at 25° C. is preferably 5.0 to 6.0 (mPa·s), and most preferably 5.5 to 5.75 (mPa·s). An appropriate amount of the white ink is preferably 2 to 10 (μL), and most preferably 3 to 7 (μL).

Next, the warm air blowing nozzle 15 will be described with reference to FIG. 1. The warm air blowing nozzle 15 blows warm air toward the printing substrate M passed under the precoating head unit 11 and the white-ink head unit 13. Thus, the solvent such as water contained in the precoating liquid and white ink evaporates, and the ejected precoating liquid and white ink are pre-dried. The warm air blowing nozzle 15 is an example of the pre-drying part which pre-dries the printing substrate M in the present disclosure.

Next, the color-ink head unit 17 will be described with reference to FIG. 1. The color-ink head unit 17 includes the four head units 17B, 17C, 17M and 17Y which eject four colors (black, cyan, magenta, and yellow) of ink to the color image forming region on the printing substrate M. The four color-ink head units 17 are arranged in order along the conveying direction X.

Each color-ink head unit 17 has the same configuration as the precoating head unit 11 shown in FIG. 2, and includes three print heads 41 and a plate 43 for supporting the three print heads 41. The four colors (black, cyan, magenta and yellow) of ink are supplied to the three print heads 31 of the four color-ink head units 17, respectively.

The color ink contains a pigment and a binder resin. The binder resin may be the same as or different from the binder resin of the precoating liquid and the white ink. A viscosity of the color ink at 25° C. is higher than that of the white ink, preferably 5.5 to 6.5 (mPa·s), and most preferably 5.75 to 6.0 (mPa·s). An appropriate amount of the color ink is smaller than an appropriate amount of the white ink, preferably 0.5 to 5 (μL), and most preferably 0.75 to 2 (μL).

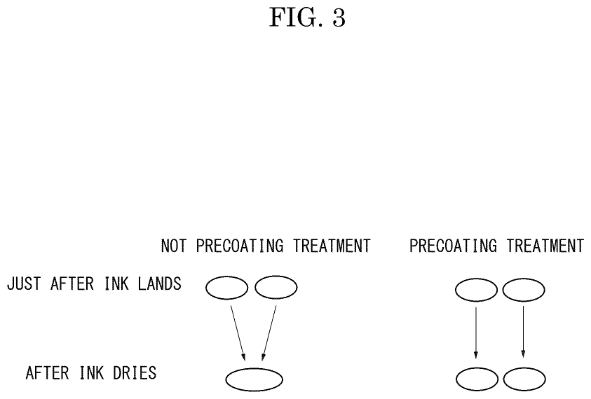

Next, the conveying plate 19 will be described with reference to FIG. 1. The conveying plate 19 is arranged between the feed roller 3 and the drying part 7 under the precoating head unit 11, the white-ink head unit 13, the warm air blowing nozzle 15 and the color-ink head unit 17. The upper surface of the conveying plate 19 is formed flat. As shown in FIG. 3, the width of the conveying plate 19 is wider than the width of the printing substrate M and all the head units 11, 13 and 17. A heater 51 is provided below the conveying plate 19. The heater 51 heats the conveying plate 19 to a predetermined temperature. The conveying plate 19 is made of, for example, metal. The heater 51 is, for example, a halogen heater, a ceramic heater, a high frequency induction heating (IH), a hot water or the like.

Next, the drying part 7 will be described with reference to FIG. 1. The drying part 7 dries the image formed on the printing substrate M by the image forming part 5. The drying part 7 is provided with a heat drum 61, and upstream-side and downstream-side tension rollers 63, 65 arranged on the upstream side and downstream side of the heat drum 61. The printing substrate M passed through the image forming part 5 is wound around the heat drum 61 between the upstream side and the downstream side tension rollers 63 and 65. The heat drum 61 is heated to dry the printing substrate M conveyed along the surface.

Next, the winding roller 9 will be described with reference to FIG. 1. The end of the printing substrate M is fixed to the winding roller 9. The winding roller 9 is connected to a motor (not shown) and rotates. By rotating the winding roller in a predetermined direction at a predetermined rotational speed by the motor, the printing substrate M is fed from the feed roller 3.

The fed printing substrate M passes under the image forming part 5 along the upper surface of the conveying plate 19, is wound around the heat drum 61 in the drying part 7, and is then wound around the winding roller 9.

In the inkjet image forming apparatus 1 having the above configuration, an image forming operation on the non-absorbent printing substrate M (a plastic film) will be described. The image includes a white image and a color image other than white color. First, the winding roller 9 is driven and rotated by the motor, and the printing substrate M is fed from the feed roller 3. The printing substrate M is conveyed along the upper surface of the conveying plate 19 below the image forming part 5.

In the image forming part 5, the precoating liquid, the white ink and the four colors of ink are ejected from the precoating head unit 11, the white-ink head unit 13 and the color-ink head unit 17, respectively. Specifically, the white ink is ejected from the white-ink head unit 13 to the white image forming region (a region where the white image in the image is formed) of the printing substrate M.

The white ink is ejected from the white-ink head unit 13 or the precoating liquid is ejected from the precoating head unit 11 to the color image forming region (a region where the color image in the image is formed) of the printing substrate M. In the case of the color image having a high opacifying property (opacity) (the color image cannot be seen through), the white ink is ejected from the white-ink head unit 13. On the other hand, in the case of the color image having a low opacifying property (opacity) (the color image can be seen through), the precoating liquid is ejected from the precoating head unit 11. The region where the white ink is ejected from the white-ink head unit 13 does not overlap with the region where the precoating liquid is ejected from the precoating head unit 11. The ejection of the white ink or the precoating liquid to the color image forming region before ejecting the color ink is referred to as the precoating treatment.

Thereafter, the printing substrate M is conveyed below the warm air blowing nozzle 15, and the white ink and the solvent contained in the precoating liquid are pre-dried.

Thereafter, the printing substrate M is conveyed below the color-ink head unit 17, and the color ink is ejected from the color-ink head unit 17 to the color image forming region. As described above, the color image forming region is subjected to the precoating treatment by the white-ink head unit 13 or the precoating head unit 11. While the printing substrate M is conveyed below the image forming part 5 in this manner, the image is dried by the heated conveying plate 19.

Thereafter, the printing substrate M on which the image is formed is conveyed to the drying part 7. The ink is completely dried in the drying part 7. Thereafter, the printing substrate M is wound around the winding roller 9.

As described above, according to the present disclosure, the white image forming region of the printing substrate M is not subjected to the precoating treatment. In order to increase opacifying property (opacity), the white ink has a larger ejection amount (appropriate amount) and a lower viscosity than the color ink, as described above. The white ink generally contains water and a high boiling point material having a higher boiling point than water. Water is easier to be dried than the high boiling material. Therefore, an amount of the high boiling point material is reduced and the water content is increased. As a result, a viscosity of the white ink is apparently low.

Therefore, an amount of the ink ejected onto the printing substrate M, that is, an amount of the solvent contained in the printing substrate M becomes larger in the case of the white ink than in the case of color ink. When the precoating treatment is performed, an amount of the solvent contained in the precoating liquid is added, so that the solvent may not be completely dried in the drying part 7.

Therefore, the white image is formed by ejecting the white ink without applying the precoating treatments to the white image forming region. Based on experience, the white image tends to be relatively solid, making the reproducibility of thin lines less problematic. Therefore, even if the precoating treatment is not performed, problems such as ink bleeding hardly occur. On the other hand, since the color image tends to have a problem of bleeding of the ink or the like, the color image is formed by ejecting the color ink after the precoating treatment is performed.

In general, since the surface energy of the printing substrate M having a low surface tension such as a plastic film is low and stable, a droplet of the ink landed on the printing substrate M easily moves from the landing position on the printing substrate M. As a result, as shown in the left side of FIG. 3, the two adjacent ink droplets may be attracted to form one large droplet after drying. When the colors of the two adjacent ink droplets are different, the ink droplets of the two colors are mixed to form one ink droplet of a mixed color. Then, the boundaries of images of different colors are blurred, and the image quality is degraded. On the other hand, when the precoating treatment is performed, the adhesion between the ink and the printing substrate M is enhanced, and the droplet of the ink landed on the printing substrate M is difficult to move from the landing position on the printing substrate M. As a result, as shown in the right side of FIG. 3, the two ink droplets become familiar with the printing substrate M and are not attracted to each other. Therefore, the inks of the two colors are hardly mixed, and a good color image can be formed.

As described above, since the white image forming region of the printing substrate M is not subjected to the precoating treatment, it is possible to suppress the deterioration of the dryness of the white ink and improve the workability of the image forming operation.

Further, since an amount of the solvent of the white ink or the precoating liquid is reduced and the viscosity of them is increased by pre-drying in the warm air blowing nozzle 15, the ink can be reliably dried in the drying part 7 and the precoating treatment effect can be enhanced.

In the case of the color image having a high opacifying property, the color ink is ejected from the color-ink head unit 17 after the white ink is ejected from the white-ink head unit 13. When the printing substrate M is transparent (for example, PET bottle labels), the opacifying property of the printing substrate M is enhanced by forming a white image with a white ink. The opacifying property of the color image can be enhanced by superimposing the color image on the white image. On the other hand, in the case of the color image having a low opacifying property, the precoating liquid is ejected from the precoating head unit 11. Since the precoating liquid is transparent, the printing substrate M remains transparent even when the precoating liquid is ejected. By forming the color image after ejecting the precoating liquid, the color image with a low opacifying property can be formed.

The pigment of the white ink is titanium oxide and the binder resin is polyurethane resin. Titanium oxide is known as a pigment with good opacifying property. Further, since the polyurethane resin has good compatibility with the printing substrate M, the adhesion between the white ink and the printing substrate M can be enhanced.

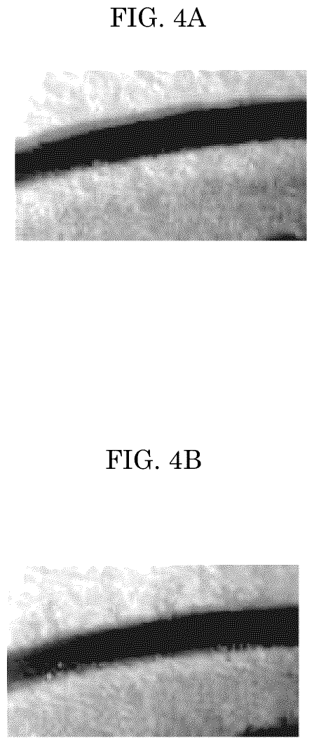

Next, the result of evaluating the adhesion of the ink in the inkjet image forming apparatus 1 of this embodiment will be described with reference to FIG. 4A and FIG. 4B. A test image with adjacent images of different colors were printed at 600 dpi. FIG. 4A is a photograph showing the test image of the present embodiment in which the color image forming region is subjected to the precoating treatment by the white-ink head unit 13. FIG. 4B is a photograph showing the test image of a comparative embodiment in which the color image forming region is not subjected to the precoating treatment.

As shown in FIG. 4A, in the present embodiment, the boundaries between the images of different colors are distinct. On the other hand, as shown in FIG. 4B, in the comparative embodiment, it can be seen that the boundaries between the images of different colors are blurred and mixed. From these results, it is confirmed that the bleeding at the boundary can be suppressed by applying the precoating treatment.

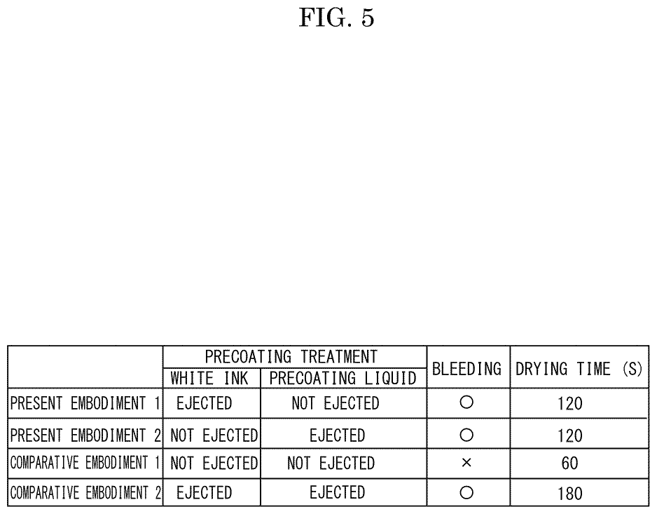

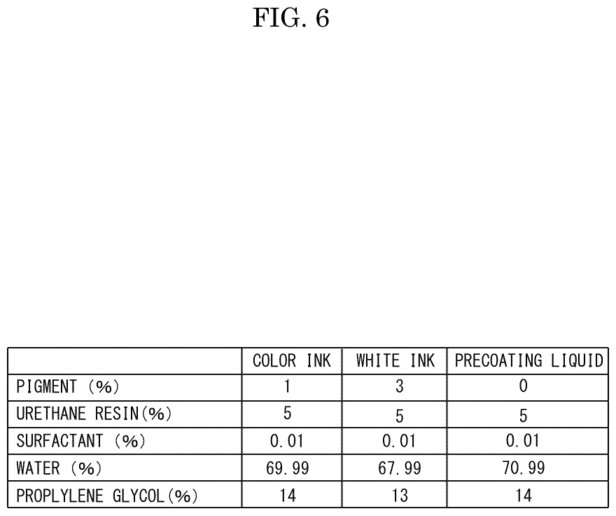

Next, the results of evaluating the bleeding and the drying time in the inkjet image forming apparatus 1 of this embodiment will be described with reference to FIG. 5 and FIG. 6. FIG. 5 is a table showing the results of evaluating the bleeding and the drying time of the present embodiment and the comparative embodiment. FIG. 6 is a table showing the components of the white ink, the color ink and the precoating liquid.

A test image in which a cyan solid image and a magenta solid image are adjacent was printed under the conditions of the present embodiments 1 and 2 and the comparative embodiments 1 and 2 shown in FIG. 5. The present embodiment 1 shows an image formed by ejecting the color ink (see FIG. 6 for components) by the color-ink head unit 17 after the precoating treatment for ejecting the white ink (see FIG. 6 for components) by the white-ink head unit 13. The present embodiment 2 shows an image formed by the color-ink head unit 17 after the precoating treatment for ejecting the precoating liquid (see FIG. 6 for components) by the precoating head unit 11. The comparative embodiment shows a case in which precoating treatment is not performed. The comparative embodiment 2 shows a case in which the precoating treatment is performed by both the white-ink head unit 13 and the precoating head unit 11.

The bleeding and drying time of the printed images were evaluated under each condition. The bleeding was evaluated in such a way that after the ink was dried, the boundary between both the images was observed under a microscope (trade name: MM-800 (manufactured by Nikon Corporation)), and the image having a boundary of a width of less than 10 μm was determined as “o” and the image having a boundary of a width of 10 μm or more was determined as “X”. The drying time indicates the time until the image is no longer attached to the hand after applying a 70° C. dryer and touching the image with the hand.

As shown in the present embodiments 1 and 2, when the precoating treatment was performed by the white-ink head unit 13 or the precoating head unit 11, no bleeding was observed. As shown in the comparative embodiment 1, the bleeding was observed when the precoating treatment was not performed. On the other hand, since the amount of moisture contained in the printing substrate M is reduced by not performing the precoating treatment, the drying time is shortened. In the comparative embodiment 2, no bleeding was observed, but the amount of moisture is increased by the amount of the white ink and precoating liquid ejected, so that the drying time was prolonged.

From these results, it was confirmed that the bleeding can be suppressed by the precoating treatment, and that the drying time can be shortened by performing the precoating treatment with either the white ink or the precoating liquid.

In this embodiment, the precoating head unit 11 is disposed on the upstream side of the white-ink head unit 13 in the conveying direction X, but may be disposed on the downstream side in the conveying direction X.

In the above embodiment, the color-ink head unit 17 for four colors of black, cyan, magenta, and yellow is used, but the present disclosure is not limited to the four colors, and may be more or less than four colors. The head units 11, 13 and 17 are not limited to a line head system. However, the line head method is preferable because the printing speed can be increased. Although a long plastic film (PET film) was used as the printing substrate M, a cut film may be used.

Although the disclosure has been described with respect to certain embodiments, the disclosure is not limited to the foregoing embodiments. The above embodiments can be modified by those skilled in the art without departing from the scope and spirit of the disclosure.

1. An inkjet image forming apparatus comprising:
a white-ink head unit which ejects white ink to a printing substrate conveyed in a predetermined conveying direction;
a precoating head unit which ejects a precoating liquid to the printing substrate; and
a color-ink head unit which is arranged on a downstream side of the white-ink head unit and the precoating head unit in the conveying direction, and ejects color ink other than the white ink to the printing base material, wherein
the white ink is ejected from the white-ink head unit to a white image forming region of the printing substrate, and
the color ink is ejected from the color-ink head unit to a color image forming region of the printing substrate after the white ink is ejected from the white-ink head unit or after the precoating liquid is ejected from the precoating head unit.

2. The inkjet image forming apparatus according to claim 1, wherein
a region where the white ink is ejected from the white-ink head unit and a region where the precoating liquid is ejected from the precoating head unit do not overlap.

3. The inkjet image forming apparatus according to claim 1, comprising:
a pre-drying part which is disposed on a downstream side of the white-ink head unit and the precoating head unit in the conveying direction, and pre-dries the printing substrate.

4. The inkjet image forming apparatus according to claim 3, wherein
the pre-drying part is a warm air blowing nozzle which blows warm air to the printing substrate.

5. The inkjet image forming apparatus according to claim 1, wherein
the white ink is ejected from the white-ink head unit to the color image forming region having an opacifying property of a predetermined value or more, and a precoating liquid is ejected from the precoating head unit to the color image forming region having an opacifying property less than the predetermined value.

6. The inkjet image forming apparatus according to claim 1, wherein
a pigment of the white ink is titanium oxide.

7. The inkjet image forming apparatus according to claim 1, wherein
a binder resin of the white ink and the precoating liquid is a polyurethane resin.

8. The inkjet image forming apparatus according to claim 1, wherein
a viscosity of the white ink is 5.5 to 6.5 mPa·S and a viscosity of the color ink is 5.0 to 5.0 mPa·S.

9. The inkjet image forming apparatus according to claim 1, wherein
an appropriate amount of the white ink is 0.5 to 5 μL and an appropriate amount of the color ink is 2 to 10 μL.

10. The inkjet image forming apparatus according to claim 1, wherein
the printing substrate is a plastic film.
